(19) United States
(12) Patent Application Publication
(10) Pub. No.: US 2017/0302366 A1
(43) Pub. Date: Oct. 19, 2017

(54) ANTENNA ARRAY ON MOVING NODES

(71) Applicant: EMPIRE TECHNOLOGY DEVELOPMENT LLC, Wilmington, DE (US)

(72) Inventors: Xuefeng Yin, Shanghai (CN); Meng Tian, Shanghai (CN)

(73) Assignee: EMPIRE TECHNOLOGY DEVELOPMENT LLC, Wilmington, DE (US)

(21) Appl. No.: 15/518,122

(22) PCT Filed: Oct. 10, 2014
(86) PCT No.: PCT/CN2014/088282

§ 371 Date: Apr. 10, 2017

(51) Int. Cl. H04B 7/185; H04L 12/24; H04W 84/06; H04W 84/18; H04W 84/00

(52) U.S. Cl. CPC H04B 7/18523; H04L 41/0803; H04W 84/005; H04W 84/18; H04W 84/06

(57) ABSTRACT

Techniques related to methods, non-transitory computer readable mediums and computing devices configured to share content received from a satellite in an ad-hoc network are generally described. One example method may include configuring a first moving node in the ad-hoc network to receive a first version of the content from a second moving node in the ad-hoc network and to receive a second version of the content from a third moving node in the ad-hoc network. The example method may further include processing the first version of the content and the second version of the content at the first moving node according to the characteristics of the first version of the content and the second version of the content, respectively. The example method may also include transmitting a processed version of the content based on the processed first version of the content and the processed second version of the content to the second moving node and the third moving node.

### BACKGROUND

Unless otherwise indicated herein, the approaches described in this section are not prior art to the claims in this application and are not admitted to be prior art by inclusion in this section.

Entertainments in a moving vehicle, such as satellite television programs, are possibie for the vehicle equipped with high performance antennas (e.g., parabolic antennas), specially designed mechanical systems that control such antennas, and a satellite receiver. However, given the specific requirements of the aforementioned devices, installing these devices in an ordinary vehicle can be prohibitively costly.

### SUMMARY

In accordance with at least some embodiments of the present disclosure, a method to share content received from a satellite in an ad-hoc network comprising a plurality of moving nodes is disclosed. The method may include configuring a first moving node in the ad-hoc network to receive a first version of the content from a second moving node in the ad-hoc network and to receive a second version of the content from a third moving node in the ad-hoc network. The method may further include processing the first version of the content and the second version of the content at the first moving node according to the characteristics of the first version of the content and the second version of the content, respectively. The method may also include transmitting a processed version of the content based on the processed first version of the content and the processed second version of the content to the second moving node and the third moving node.

In accordance with at least some embodiments of the present disclosure, a non-transitory computer readable medium containing instructions for sharing content received from a satellite in an ad-hoc network comprising a plurality of moving nodes is disclosed. When the contained instructions are executed by a host processor, the host processor may be configured to configure a first moving node in the ad-hoc network to receive a first version of the content from a second moving node in the ad-hoc network and to receive a second version of the content from a third moving node in the ad-hoc network. The host processor may be further configured to process the first version of the content and the second version of the content at the first moving node according to the characteristics of the first version of the content and the second version of the content, respectively; and to transmit a processed version of the content based on the processed first version of the content and the processed second version of the content to the second moving node and the third moving node, respectively.

In accordance with at least some embodiments of the present disclosure, a computing device configured to share content received from a satellite in an ad-hoc network comprising a plurality of moving nodes is disclosed. The computing device may include a first antenna in the antenna array and a processor coupled to the first antenna. The processor may be configured to configure a first moving node in the ad-hoc network and coupled to the first antenna to receive a first version of the content from a second moving node in the ad-hoc network and coupled to a second antenna and to receive a second version of the content from a third moving node in the ad-hoc network and coupled to the third antenna. The second antenna and the third antenna are configured to simultaneously receive the content from the satellite. The processor may be also configured to process the first version of the content and the second version of the content at the first moving node according to the characteristics of the first version of the content and the second version of the content, respectively. The processor may be further configured to transmit, by the first antenna, a processed version of the content based on the processed first version of the content and the processed second version of the content to the second moving node and the third moving node, respectively, in which the second antenna and the third antenna are configured to receive the processed version of the content.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several examples in accordance with the disclosure and are therefore not to be considered limiting of its scope, the disclosure will be described with additional specificity and detail through use of the accompanying drawings.

In the drawings:

FIG. 1 illustrates an example network configured to process a signal transmitted by a satellite;

FIG. 2 is a flow chart of an example method to process a signal transmitted by a satellite in a network;

FIG. 3 is a block diagram of an example computer program product to implement a method to process a signal transmitted by a satellite in a network; and

FIG. 4 is a block diagram of an example computing device configured to process a signal transmitted by a satellite in a network, all arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

This disclosure is drawn, inter alia, to methods, apparatuses, computer programs, and systems related to processing a signal in a moving and dynamic network. The moving and dynamic network may include multiple moving nodes (e.g., vehicles). The signal may be transmitted by an outside node (e.g., a satellite) which may not be a part of the moving and dynamic network. Because a first channel between a moving node in the moving and dynamic network may be different from a second channel between another moving node in the moving and dynamic network, nodes in the moving and dynamic network may receive different versions of the signal transmitted by the outside node. Accordingly, the versions of the signal may be processed to obtain the original signal transmitted by the outside node.

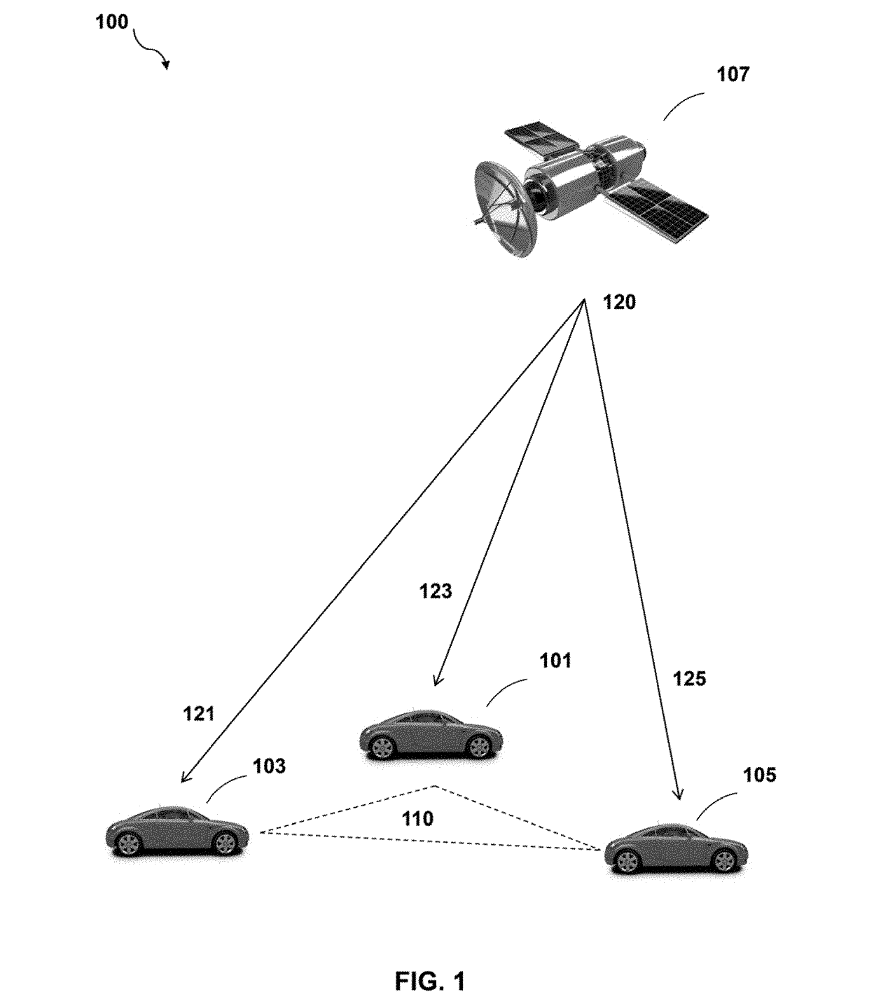

FIG. 1 illustrates an example network 110 configured to process a signal transmitted by a satellite 107 in accordance with at least some embodiments of the disclosure. The example network 110 may include a first node 101, a second node 103 and a third node 105. The network 110 may be self-formed, e.g., an ad-hoc network. The first node 101, the second node 103 and the third node 105 may be moving, e.g., moving vehicles. In the network 110, information associated with the first node 101, the second node 103 and the third node 105 may be configured to be exchanged. The exchanged information may include, but not limited to, speed, location, direction, antenna configuration and multimedia processor specification of any of the first node 101, the second node 103 and the third node 105.

Any of the first node 101, the second node 103 and the third node 105 may establish a communication with the satellite 107. Any of the first node 101, the second node 103 and the third node 105 may include an antenna configured to work within a bandwidth compatible with the frequency band of the satellite 107 to establish a communication channel with the satellite 107. Accordingly, a first communication channel 121 may form between the first node 101 and the satellite 107, a second communication channel 123 may form between the second node 103 and the satellite 107, and a third communication channel 125 may form between the third node 105 and the satellite 107.

The information transmitted by the satellite 107 may be received by any of the first node 101, the second node 103 and the third node 105. The information may include, but not limited to, multimedia contents. However, given the geographic and environmental differences among the nodes of the network 110, some information transmitted by the satellite 107 may be blocked by mountains or interfered by clouds. The first node 101, the second node 103 and the third node 105 may receive different versions of the same multimedia contents transmitted by the satellite 107.

At least one of the nodes in the network 110 is selected as a “processing node.” The processing node may be selected according to the information exchanged in the network 110. For example, a node having a relative highly powerful multimedia processor may be selected as the processing node. Some nodes in the network 110 are selected as “relaying nodes.” The relaying nodes may be configured to relay signals received from the satellite 107 to the processing node. The processing node may be configured to receive and process versions of the multimedia contents from relaying nodes in the network 110. After the multimedia contents are processed by the processing node, the processing node may be configured to transmit the processed multimedia contents in the network 110.

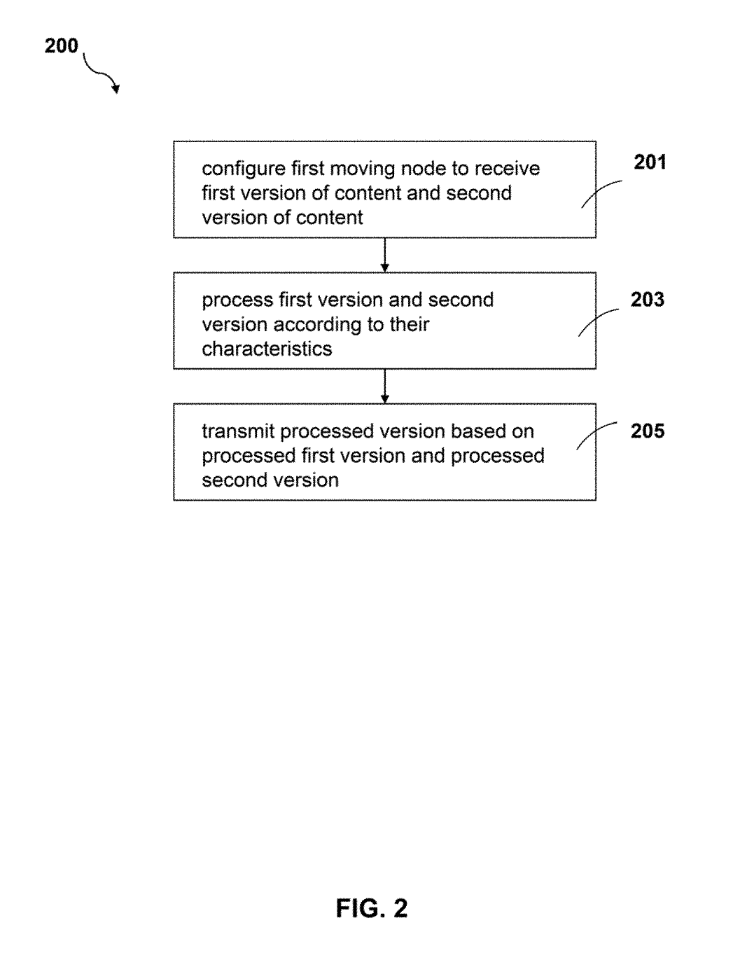

FIG. 2 is a flow chart of an example method 200 to process a signal transmitted by a satellite in a network in accordance with at least some embodiments of the disclosure. Method 200 may begin in block 201.

In block 201, a first node in the network may be configured to receive the signal relayed by a second node in the network and a third node in the network. In the network, the information associated with a node in the network may be exchanged to another node in the network. Such information may include speed, location, antenna, processor and transmission ability information. The exchanged information may be broadcasted in the network so that a node may acknowledge the speed, location, antenna, processor and transmission ability information of other nodes in the network. According to the exchanged information, appropriate nodes may be selected. For example, the information associated with the first node may indicate that the first node comprise a relatively high powerful processor so that the first node is more capable to process the signal than other nodes. The information associated with the second node and the third node may indicate that the any of the second node and the third node comprises an antenna (e.g., Doppler antenna or parabolic antenna) to receive the signal from the satellite and an optical device or a microwave device to relay the received signal to the first node. In some embodiments. a first moving node may include a processor which is more powerful (for example, having a higher clock speed, faster processing speed for a given task, and/or more processor cores) than any processors included in a second moving node, third moving node, or other moving node if present.

The first node may be the “processing node” as set forth above. The second node and the third node may possess some characteristics to maintain the relay. For example, the speeds of the second node and the third node are less than a threshold, the distances between the second node and the first node and between the third node and the first node are less than a threshold, the quality of the channels between the second node and the first node and between the third node and the first node are better than a threshold, etc.

In some embodiments, the second node may relay a first version of a content included in the signal. The third node may relay a second version of the content included in the signal. The versions of the content depend on the variations of the channel between the second node and the satellite and the channel between the third node and the satellite. Block 201 may be followed by block 203.

In block 203, the first node may be configured to process the first version of the content and the second version of the content according to the characteristics of the first version of the content and the second version of the content. The first version of the content may be associated with a first channel between the second node and the satellite. The second version of the content may be associated with a second channel between the third node and the satellite. The similarity between the first channel and the second channel is correlated with the similarity of the first version and the second version. In some embodiments, the similarity between the first channel and the second channel may be achieved by comparing a first channel impulse response associated with the first channel and a second channel impulse response associated with the second channel. If the first channel impulse response and the second channel impulse response are substantially the same, then the first channel and the second channel will be similar. In some other embodiments, if the second nodes and the third nodes are physically separated, the first channel and the second channel will not be determined as similar.

In some embodiments, the version of the content y,(t) received on the i-th node of the network may be denoted:

yᵢ(t)=∫exp(j2rvt)x(t−τ)hᵢ(v,τ)dvdτ+nᵢ(t)

wherein hᵢ(v,τ) denotes the spread function of a channel between a node in the network and the satellite, x(t) denotes the original signal transmitted by the satellite, nᵢ(t) denotes the white Gaussian thermal noise, τ denotes the delay of signals due to the propagation, v denotes the Doppler frequency of the signals due to the relative movement of the nodes and the satellite and t denotes time. The version of the content yᵢ(t) may be received by a receiver at a node. The receiver may include a local oscillator fixed at the carrier frequency corresponding to the signals transmitted by the satellite.

The first node may receive y₁(t), y₂(t) . . . yₙ(t) from all n nodes of the network, respectively. In some embodiments, the first node may determine the difference between the first version of the content and the second version of the content is less than a threshold. For example, a first phase of a first channel coefficient associated with the first channel may be close to a second phase of a second channel coefficient associated with the second channel (e.g., within 90 degrees). Accordingly, the first node may be configured to sum the first version of the content and the second version of the content up to generate a processed version of the content. The first node may then be configured to demodulate and decode the processed version of the content to obtain the signal transmitted by the satellite.

In some embodiments, the first node may determine the difference between the first version of the content and the second version of the content is greater than or equal to a threshold. The first node may be configured to require additional information from the second node and the third node. Such additional information may be used to compensate the environment effects to the first channel and the second channel. Therefore, the first version of the content and the second version of the content may be aligned accordingly. In some embodiments, the first node may be configured to align the first version of the content and the second version of the content. An aligned version of the content may be denoted:

$${\sum }_{i = 1}^{t} \int {y}_{i} ( t ) exp ( - j 2 rvt ) * δ ( t - τ ) ( v , τ ) dvd τ$$

wherein there are I versions of the content received by the first node, yᵢ(t) denotes a version of the content received from the i-th node in the network, δ(t−τ) denotes a dirac delta function delayed by τ. [symbol] (v,τ) denotes the estimated channel spread function of the i-th node, τ denotes the delay of signals due to the propagation, v denotes the Doppler frequency of the signals due to the relative movement of the nodes and the satellite and t denotes time.

In some embodiments, the first node may receive more than two versions of the content from multiple nodes in the network. The difference among some similar versions may be smaller than a threshold while the difference among the rest different versions may be greater than or equal to the threshold. The first node may sum up the similar versions to generate a first processed version as set forth above. For example, the first node may use an equal gain combining scheme to sum up the similar versions. The first node may align the different versions to generate a second processed version as set forth above. For example, the first node may use a diversity scheme to align the different versions. Block 203 may be followed by block 205.

In block 205, the first node may be configured to transmit the processed version of the content in the network. The processed version may be received by other nodes in the network. Accordingly, the content included in the signals transmitted by the satellite may be received by other nodes in the network.

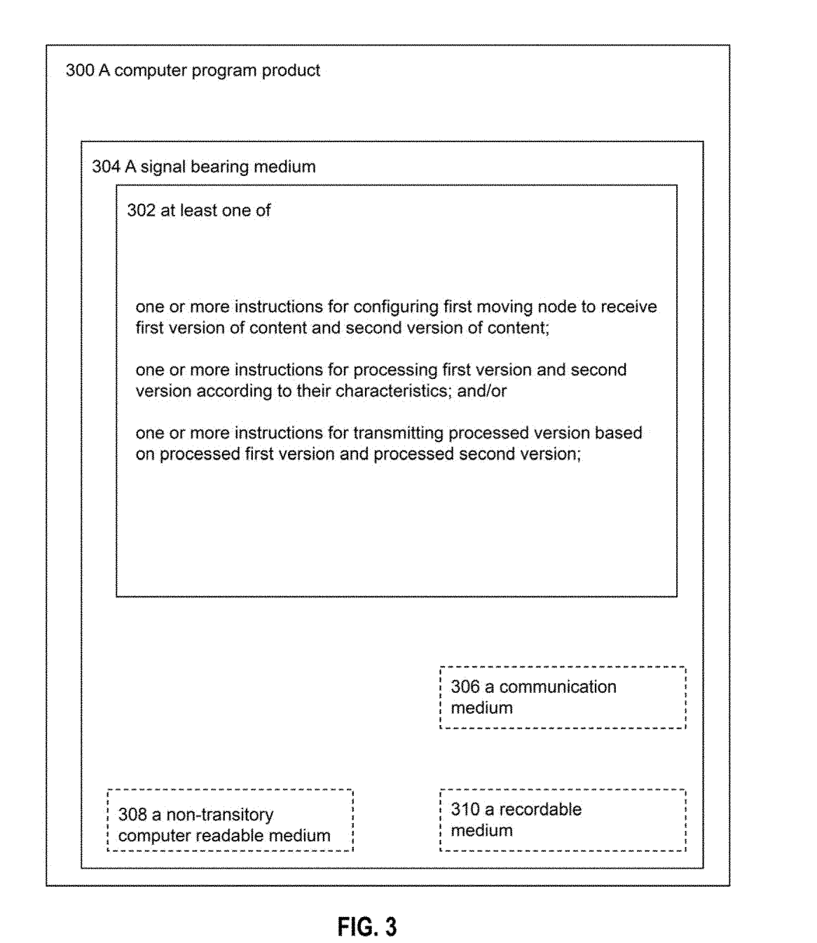

FIG. 3 is a block diagram of an illustrative embodiment of a computer program product 300 to implement a method to process a signal transmitted by a satellite in a network. Computer program product 300 may include a signal bearing medium 302. Signal bearing medium 302 may include one or more sets of executable instructions 304 stored thereon that, in response to execution by, for example, a processor, may provide the features and operations described above.

In some embodiments. signal bearing medium 302 may encompass a non-transitory computer readable medium 306, such as, but not limited to, a hard disk drive, a Compact Disc (CD), a Digital Versatile Disk (DVD), a digital tape, memory, etc. In some implementations, signal bearing medium 302 may encompass a recordable medium 308, such as, but not limited to, memory, read/write (R/W) CDs, R/W DVDs, etc. In some implementations, signal bearing medium 302 may encompass a communications medium 310, such as, but not limited to, a digital and/or an analog communication medium (e.g., a fiber optic cable, a waveguide, a wired communications link, a wireless communication link, etc.). Thus, for example, referring to FIG. 1, computer program product 300 may be wirelessly conveyed to any of the nodes 101, 103 and 105 by signal bearing medium 302, where signal bearing medium 302 is conveyed by communications medium 310 (e.g., a wireless communications medium conforming with the IEEE 802.11 standard). Computer program product 300 may be recorded on non-transitory computer readable medium 306 or another similar recordable medium 308.

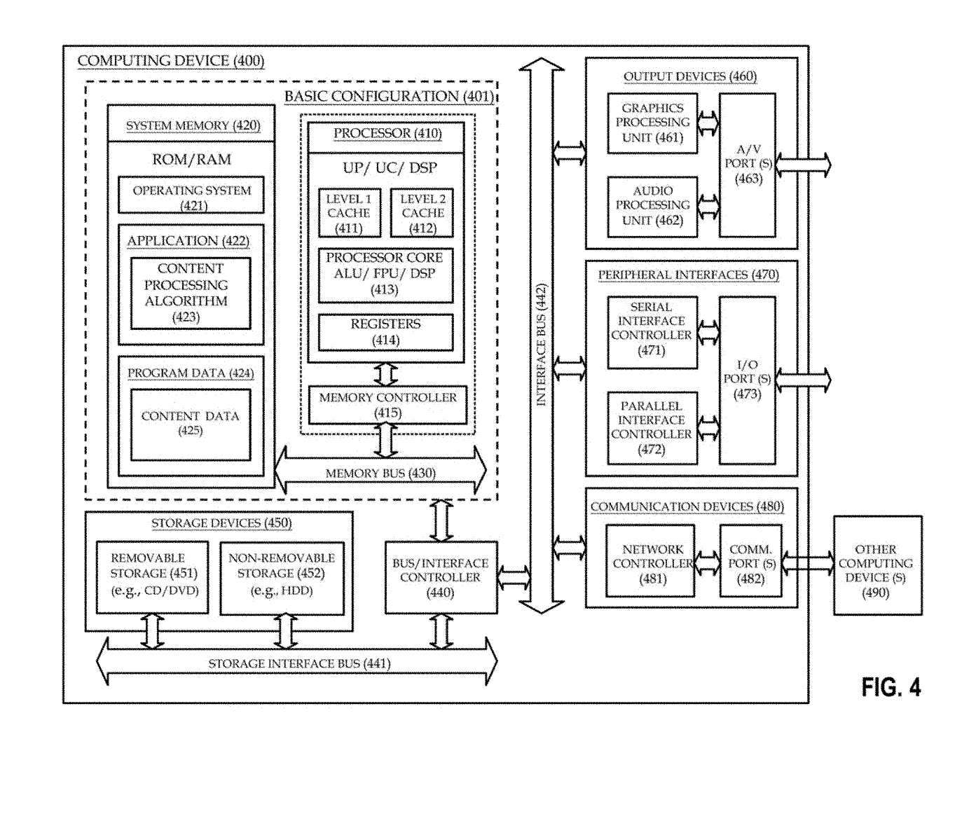

FIG. 4 shows a block diagram of an illustrative embodiment of an example computer system 400. In a very basic configuration 401, the computer system 400 may include one or more processors 410 and a system memory 420. A memory bus 430 may be used to communicate between the processor 410 and the system memory 420.

Depending on the desired configuration, processor 410 may be of any type including but not limited to a microprocessor (μP), a microcontroller (μC), a digital signal processor (DSP), or any combination thereof. Processor 410 can include one or more levels of caching, such as a level one cache 411 and a level two cache 412, a processor core 413, and registers 414. The processor core 413 can include an arithmetic logic unit (ALU), a floating point unit (FPU), a digital signal processing core (DSP Core), or any combination thereof. In some embodiments, the first node in the network 110 (such as shown in FIG. 1) may be implemented by the processor 410. A memory controller 415 can also be used with the processor 410, or, in some implementations the memory controller 415 can be an internal part of the processor 410.

Depending on the desired configuration, the system memory 420 may be of any type including but not limited to volatile memory (such as RAM), non-volatile memory (such as ROM, flash memory, etc.) or any combination thereof. The system memory 420 may include an operating system 421, one or more applications 422, and program data 424. The application 422 may include a content processing application 423 that is arranged to perform the operations as described herein including at least the operations described with respect to the first node in the network 110 of FIG. 1 and/or described elsewhere in this disclosure. The program data 424 may include content data 425 to be accessed by the content processing application 423, and/or may include other objects, code, data, instructions, etc. as described herein.

Computing device 400 may have additional features or functionality, and additional interfaces to facilitate communications between basic configuration 401 and any required devices and interfaces. For example, a bus/interface controller 440 may be used to facilitate communications between basic configuration 401 and one or more data storage devices 450 via a storage interface bus 441. Data storage devices 450 may be removable storage devices 451, non-removable storage devices 452, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

System memory 420, removable storage devices 451, and non-removable storage devices 452 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store the desired information and which may be accessed by computing device 400. Any such computer storage media may be part of computing device 400.

Computing device 400 may also include an interface bus 442 to facilitate communication from various interface devices (e.g., output devices 460, peripheral interfaces 470, and communication devices 480) to basic configuration 401 via bus/interface controller 440. Example output devices 460 include a graphics processing unit 461 and an audio processing unit 462, which may be configured to communicate to various external devices such as a display or speakers via one or more A/V ports 463. Example peripheral interfaces 470 include a serial interface controller 471 or a parallel interface controller 472, which may be configured to communicate with external devices such as input devices (e.g., keyboard, mouse, pen, voice input device, touch input device, etc.) or other peripheral devices (e.g., printer, scanner, etc.) via one or more I/O ports 473. An example communication device 480 includes a network controller 481, which may be arranged to facilitate communications with one or more other computing devices 490 over a network communication link via one or more communication ports 482. In some implementations, computing device 400 includes a multi-core processor, which may communicate with the host processor 410 through the interface bus 442.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may iinclude wired media such as a wired network or direct-wired connection, and wireless media such as acoustic, radio frequency (RF), microwave, infrared (IR) and other wireless media. The term computer readable media as used herein may include both storage media and communication media.

Computing device 400 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 400 may also be implemented as a personal computer including both laptop computer and non-laptop computer configurations.

The use of hardware or software may be generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

In some embodiments, an ad hoc network of moving nodes may comprise an ad hoc network of nodes, each node being located in a vehicle. In some embodiments, the vehicle nodes may operate cooperatively (e.g. jointly) to process satellite signals, allowing higher signal to noise power ratio gains to be achieved for each node. In some embodiments, each vehicle may comprise a satellite receiver, which receives signals emitted by a satellite. In some examples, other wireless signals may be received, such as antenna-transmitted signals. Satellite signals may have one or more specific center frequencies and a bandwidth, and in some examples a bandwidth may range from 3 MHz to 8 MHz. For example, using MPEG-4 compression, a satellite program (such as a TV program) may use 3 MHz bandwidth for transmission. In some embodiments, each vehicle in an ad-hoc self-organizing network may relay the received signals to a hub vehicle. The hub vehicle may comprise an electronic circuit, such as a computer comprising a processor and associated components, configured to demodulate the satellite signal. Transmission (up-link transmission) from a plurality of vehicles to the hub vehicle may be coordinated using a specific communication protocol which allocates a channel (e.g. a 3 MHz channel) to each vehicle. For example, if there were ten vehicles transmitting simultaneously the TV programs to the hub vehicle, a 30 MHz bandwidth would used for uplink transmission. For downlink transmission, the hub vehicle may transmits the program back to each vehicle, using either use a broadcasting downlink channel, for example using only one 30 MHz channel, or by assigning a specific channel to a particular vehicle.

Vehicle-to-vehicle communication systems may readily allow 60 MHz bandwidth, including 30 MHz uplink and 30 MHz downlink, In 5G communication, including 5G vehicular communication, a frequency band beyond 20 GHz may be used. The bandwidth of proposed 5G systems may be from 500 MHz to 2 GHz. Therefore, vehicle-to-vehicle communication systems may readily relay satellite TV programs between networked vehicles using 60 MHz bandwidth, or greater.

In some embodiments, vehicles (or more generally, any moving nodes) may be selected (or self-select) to organize as an ad-hoc network. Selection may be based on one or more parameters, such as vehicle speed, direction, destination (if known), indicated preference to join a network, program preferences, and the like. One vehicle may serve as a hub, for example based on equipment available in that vehicle (or other factors), and may broadcast an inquiry message to all the vehicles in the network. For example, the inquiry message may ask the network vehicles to clarify which TV programs are preferable by the users of the vehicles. Such a preference list of the TV programs may be pre-determined by the vehicle users, and for example stored in a memory associate with the vehicle (for example, associated with a node located in the vehicle, or accessible through a local network or global network such as the Internet). In some examples, when more than a predetermined number of vehicle indicate a preference to watch a particular program or type of program, then the hub vehicle may select those vehicles to receive the preferred program, type of program, subscription to a program content provider, and the like. For example, if more than five vehicles select to watch CNN, CNN programs may be received from the satellite and transmitted to the selected vehicles, optionaliy along with a warning to not operate a vehicle when drowsy and/or watching television, or similar warning(s). In some examples, once the number of vehicles indicating a preference for a TV program exceeds a pre-determined threshold, then these vehicles may be organized as a network for receiving that program. For selected vehicles agreeing to receive the same TV program, the hub vehicle send a message to these vehicles, requesting that the vehicle receive the TV program at specific center frequency e.g. in Ku-band, using 3 MHz bandwidth. The vehicles may then relay the TV program to the hub, using different channels assigned by the hub. In some examples, up to N channels may be assigned by the hub to N vehicles, where N may be 10, 12, 20, 50, or other number. The hub may then demodulate the TV program satellite signals, and transmit the program back to the cars in the network using downlink channels. An advantage of an ad-hoc network may be that, since this network may be used for receiving a specific TV program, the hub or even other members of the network can broadcast the TV program to other users not belonging to the network, or to the other users which do not have the capability of receiving TV programs directly from a satellite, provided that a suitable vehicle-to-vehicle communication protocol is available.

In some embodiments, an ad-hoc organized set of vehicles operates as a cooperative antenna array to provide better reception of signals using smaller antennas on each vehicle. In some embodiments, satellite TV is enabled for each vehicle of a network using small antennas (compared with a conventional satellite antenna), for example using one relatively small antenna on each vehicle. A plurality of networked vehicles may provide a plurality of antennas, which may cooperatively perform as an antenna array. In contrast, a single vehicle requiring satellite TV would require a larger antenna that may occupy a considerable portion of the vehicle roof space, reducing the aesthetic appeal of any vehicle and reducing gas mileage due to increased drag. Some embodiments allow satellite TV reception via smaller antennas, in some examples simple whip antennas, where such antennas may be easier to implement physically, or installed as original equipment on a vehicle.

In some embodiments, an ad hoc vehicle network may be formed within vehicle platoon, for example as part of an improved, intelligent transportation system. In some embodiments, moving nodes (for example associated with moving vehicles) arranged in an ad hoc network may be moving with approximately similar speeds, for example each vehicle having a speed within 10 mph, 5 mph, or less different from that of the hub vehicle, or other vehicle(s) within a network. A hub vehicle may communicate its speed to other vehicles within the network, for example by transmitting vehicle speed data from a cruise control system, speed sensor, or other device or sensor. A vehicle within an ad hoc network may adjust speed based on received speed data from one or more other vehicies within the network, and/or based on position data received from other vehicles (for example to remain within communication range of one or more other vehicles within the network). Vehicles may leave or join an ad hoc network according to conditions, for example a vehicle may leave an ad hoc network if it goes beyond a communication range of a hub vehicle or other vehicle within the ad hoc network. Vehicles may join an ad hoc network, for example by sending a request to a hub vehicle or other vehicle within the network which may then be accepted, for example through recognition of acceptable credentials. In some embodiments, a moving node may be a node moving relative to the surface of the Earth, for example a node within or otherwise associated with a vehicle moving along a road. In some examples, a node may comprise an electronic circuit, such as an electronic circuit associated with a vehicle, and in some examples an electronic circuit may comprise a wireless transceiver, processor, memory, and associated components. In some examples, a node may comprise vehicle electronics, such as a vehicle entertainment system (or component thereof) associated with a vehicle, or a portable electronic device associated with a vehicle occupant (such as a driver and/or passenger). In other embodiments, an ad hoc network may be formed using nodes associated with a plurality of parked vehicles. In some embodiments, vehicles may be land vehicles, such as automobiles, trucks, buses, motorcycles, and the like. In some embodiments, vehicles may be flying vehicles (such as airplanes, UAVs, and the like), boats, and the like. In some examples, moving nodes may be provided by pedestrians, the nodes being provided by portable electronic devices carried by the pedestrians, allowing pedestrians to receive satellite television on a portable electronic device. In some examples, moving nodes may comprise a plurality of portable electronic devices carried by users on a public transport vehicle, such as a train, bus, ferry, and the like, and an ad hoc network may be formed by a plurality of nodes each essentially moving at the speed of the public transport vehicle.

In some embodiments, vehicle billing for received programs may be based on total data transferred to the vehicle, reception time (e.g. time in the ad hoc network), subscription or fees for predetermined programs, some combination thereof, and the like.

In some examples, a network may be used to share safety information such as road condition information (such as presence of ice, dangerous conditions, traffic backups, and the like), weather information, approaching emergency vehicles, or other safety-related information.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples can be implemented, individually and/or collectively, by a wide range of hardware, software, firmware, or virtually any combination thereof. In some embodiments, several portions of the subject matter described herein may be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware are possible in light of this disclosure. In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably coupable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to”, etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.), It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, various embodiments of the present disclosure have been described herein for purposes of illustration, and various modifications may be made without departing from the scope and spirit of the present disclosure. Accordingly, the various embodiments disclosed herein are not intended to be limiting, with the true scope and spirit being indicated by the following claims

1. A method to share content received from a satellite in an ad-hoc network comprising a plurality of moving nodes, the method comprising:
configuring a first moving node to receive a first version of the content from a second moving node and to receive a second version of the content from a third moving node;
processing the first version of the content and the second version of the content at the first moving node according to characteristics of the first version of the content and characteristics of the second version of the content, respectively; and
transmitting a processed version of the content, based on the processed first version of the content and the processed second version of the content, to the second moving node and the third moving node.

2. The method of claim 1, further comprising forming the ad-hoc network by exchanging speed, position, and resource information of the first moving node with the second moving node and the third moving node.

3. The method of claim 1, wherein the first moving node includes a processor which is more powerful than processors included in the second moving node and the third moving node.

4. The method of claim 1, further comprising estimating a distance between the first moving node and the second moving node during a period of receiving the first version of the content from the second moving node.

5. The method of claim 1, wherein the characteristics of the first version of the content are associated with a first channel between the satellite and the second moving node and the characteristics of the second version of the content are associated with a second channel between the satellite and the third moving node.

6. The method of claim 5, further comprising determining a difference between the first version of the content and the second version of the content.

7. The method of claim 6, wherein the processing comprises summing the first version of the content and the second version of the content, in response to a determination that the difference is less than a particular value.

8. The method of claim 7, wherein a difference between a first phase of a first channel coefficient associated with the first channel and a second phase of a second channel coefficient associated with the second channel is less than 90 degrees.

9. The method of claim 6, wherein the processing comprises performing a deconvolution operation on the first version of the content and the second version of the content, in response to a determination that the difference is greater than or equal to a particular value.

10. The method of claim 1, wherein the transmitting further comprises broadcasting the processed version of the content to other nodes in the ad-hoc network.

11. A non-transitory computer readable medium comprising stored instructions, to share content received from a satellite in an ad-hoc network comprising a plurality of moving nodes, the stored instructions in response to execution by a host processor, causes the host processor to:
configure a first moving node, in the ad-hoc network, to receive a first version of the content from a second moving node, in the ad-hoc network, and to receive a second version of the content from a third moving node in the ad-hoc network;
process the first version of the content and the second version of the content at the first moving node according to characteristics of the first version of the content and characteristics of the second version of the content, respectively; and
transmit a processed version of the content, based on the processed first version of the content and the processed second version of the content, to the second moving node and the third moving node.

12. The non-transitory computer readable medium of claim 11, further comprising additional instructions, which in response to execution by the host processor, causes the host processor to exchange speed, position, and resource information of the first moving node with the second moving node and the third moving node.

13. The non-transitory computer readable medium of claim 11, further comprising additional instructions, which in response to execution by the host processor, causes the host processor to estimate a distance between the first moving node and the second moving node during a period of receiving the first version of the content from the second moving node.

14. The non-transitory computer readable medium of claim 11, wherein the characteristics of the first version of the content are associated with a first channel between the satellite and the second moving node and the characteristics of the second version of the content are associated with a second channel between the satellite and the third moving node.

15. The non-transitory computer readable medium of claim 14, further comprising additional instructions, which in response to execution by the host processor, causes the host processor to determine a difference between the first version of the content and the second version of the content.

16. The non-transitory computer readable medium of claim 15, further comprising additional instructions, which in response to execution by the host processor, to sum the first version of the content and the second version of the content, in order to process the first version of the content and the second version of the content, in response to a determination that the difference is less than a particular value.

17. The non-transitory computer readable medium of claim 16, wherein a difference between a first phase of a first channel coefficient associated with the first channel and a second phase of a second channel coefficient associated with the second channel is less than 90 degrees.

18. The non-transitory computer readable medium of claim 15, further comprising additional instructions, which in response to execution by the host processor, to perform a deconvolution operation on the first version of the content and the second version of the content, in order to process the first version of the content and the second version of the content, in response to a determination that the difference is greater than or equal to a particular value.

19. A computing device configured to share content received from a satellite in an ad-hoc network comprising a plurality of moving nodes, the computing device comprising:
a first antenna in an antenna array;
a processor operatively coupled to the first antenna, wherein the processor is configured to:
configure a first moving node communicatively coupled to the first antenna to:
receive a first version of the content from a second moving node communicatively coupled to a second antenna, and
receive a second version of the content from a third moving node communicatively coupled to a third antenna, wherein
the second antenna and the third antenna are configured to simultaneously receive the content from the satellite;
process the first version of the content and the second version of the content at the first moving node according to characteristics of the first version of the content and characteristics of the second version of the content, respectively; and
transmit, by the first antenna, a processed version of the content, based on the processed first version of the content and the processed second version of the content, to the second moving node and the third moving node, respectively, wherein the second antenna and the third antenna are configured to receive the processed version of the content from the first antenna.

20. The computing device of claim 19, wherein the first antenna, the second antenna and the third antenna are configured to simultaneously receive the content from the satellite.
